(19) United States
(12) Patent Application Publication
(10) Pub. No.: US 2012/0096888 A1
(43) Pub. Date: Apr. 26, 2012

(54) Refrigerator with water tank

(75) Inventors: Sang Min Park, Gwangju (KR); Jae Koog An, Gwangju (KR)

(73) Assignee: SAMSUNG ELECTRONICS CO., LTD, Suwon-si (KR)

(21) Appl. No.: 13/200,924

(22) Filed: Oct. 5, 2011

(30) Foreign Application Priority Data
Oct. 21, 2010 (KR) 10-2010-0102907

(51) Int. Cl. F25D 3/00; B29C 45/17; F25D 23/00

(52) U.S. Cl. 62/318; 62/389; 220/592.02; 156/245

(57) ABSTRACT

A water tank includes a long water storage part and a partition unit including partitions to partition the water storage part into a plurality of storage spaces. Communication holes are formed at the partitions to allow the storage spaces to communicate with each other. Spatial efficiency and a first in first out effect are improved.

### CROSS-REFERENCE TO RELATED APPLICATIONS

This application claims the benefit of Korean Patent Application No. 2010-0102907, filed on Oct. 21, 2010 in the Korean Intellectual Property Office, the disclosure of which is incorporated herein by reference.

### BACKGROUND

1. Field

Embodiments relate to a refrigerator with a water tank to store water to be supplied to a dispenser.

2. Description of the Related Art

A refrigerator is an apparatus that supplies cool air into a storage chamber to keep foods fresh. The storage chamber includes a freezing chamber to keep foods at a freezing temperature or less and a refrigerating chamber to keep foods at temperature slightly higher than the freezing temperature.

In recent years, various large-sized refrigerators have been placed on the market to provide convenience and satisfy the need for a large storage space. Such refrigerators are classified into a general refrigerator having a freezing chamber provided at the upper part thereof, a side-by-side refrigerator having a freezing chamber provided at one side thereof, and a combination type refrigerator having a freezing chamber provided at the lower part thereof.

Among such refrigerators, there is a refrigerator having a dispenser provided at the front of a door so that drinks may be taken out of the dispenser or an ice maker provided in a freezing chamber to make ice.

Generally, such a refrigerator has a water supply system to supply water to the dispenser provided at the front of the door or to the ice maker provided in the freezing chamber. Also, such a refrigerator has a filter to purify water to be supplied and a water tank to store the purified water.

The water tank stores water supplied from a water supply source. Cool air stored in the water tank is supplied to the dispenser via the water supply system.

Various kinds of water tanks have been proposed which are configured to prevent mixing of room-temperature water introduced from the water supply source and cool water stored therein.

### SUMMARY

It is an aspect to provide a refrigerator with a water tank that improves spatial efficiency of the refrigerator and a first in first out effect.

It is another aspect to provide a refrigerator with a water tank that is manufactured with improved productivity.

Additional aspects will be set forth in part in the description which follows and, in part, will be apparent from the description, or may be learned by practice of the invention.

In accordance with one aspect, a water tank for refrigerators includes a housing having an inlet port, an outlet port and a water storage part to store water introduced through the inlet port, a partition unit including at least one partition mounted in the water storage part to partition the water storage part into a plurality of storage spaces, a communication hole formed at the at least one partition to allow the storage spaces partitioned by the at least one partition to communicate with each other, and a water flow route along which the water introduced into the water storage part through the inlet port flows to the outlet port via the communication hole, wherein the communication hole is formed at the at least one partition so that the water flow route has a serpentine form.

The water storage part may extend lengthwise in the longitudinal direction.

The at least one partition may be provided with a cutoff part, and the communication hole may be defined between the cutoff part and an inside of the housing.

The inlet port and the outlet port may be disposed at opposite ends of the water storage part in the longitudinal direction, respectively, and the communication hole formed at the at least one partition adjacent to the inlet port may be disposed adjacent to the upper side of the water storage part.

The inlet port and the outlet port may be disposed at one end of the water storage part in the longitudinal direction, and the water tank may further include a water tube communicating with the inlet port so that water introduced through the inlet port is discharged to a portion adjacent to the other end of the water storage part in the longitudinal direction.

The partition unit may further include a rod, opposite ends of which are supported by opposite ends of the water storage part in the longitudinal direction, respectively, and the at least one partition extends outward from the rod in the radial direction.

The partition unit may further include a rod, opposite ends of which are supported by opposite ends of the water storage part in the longitudinal direction, respectively, and the at least one partition extends from the rod in a spiral shape.

The at least one partition having the communication hole disposed adjacent to the lower side of the water storage part may be provided at the upper side thereof with an air hole, through which air is discharged.

The communication hole formed at the at least one partition having the communication hole disposed adjacent to the upper side of the water storage part may be located higher than the center of the vertical length of the housing.

The communication hole formed at the at least one partition having the communication hole disposed adjacent to the lower side of the water storage part may be located lower than the center of the vertical length of the housing.

The housing may include a first housing forming one side thereof in the longitudinal direction and a second housing forming the other side thereof in the longitudinal direction, the first housing and the second housing being coupled to each other, and the partition unit may be injection molded and may be mounted in the housing.

The first housing and the second housing may be welded to each other.

The partition unit may further include a rod extending in the longitudinal direction so that one end of the rod is supported by the first housing and the other end of the rod is supported by the second housing, the rod being disposed at the center of the vertical length of the water storage part, and the at least one partition may extend from the rod toward the inside of the housing.

In accordance with another aspect, a refrigerator includes a housing having a water storage part extending from one end to the other end in the horizontal direction and a water flow route along which water introduced into the water storage part through a portion adjacent to one end flows to an outlet port disposed adjacent to the other end and a partition unit including a plurality of partitions arranged in the water storage part at intervals in the longitudinal direction to partition the water storage part, each of the partitions having a communication hole, wherein the communication holes formed at the partitions are diametrically opposite to each other so that the water flow route has a serpentine form.

The refrigerator may further include a water supply source, an inlet port having one end connected to the water supply source and the other end connected to a portion adjacent to the other end of the water storage part, and a water tube communicating with the inlet port to allow water introduced through the inlet port to be discharged at a portion adjacent to one end of the housing.

The communication hole formed at one of the partitions adjacent to a discharge port of the water tube may be disposed adjacent to the upper side of the water storage part.

The refrigerator may further include a filter provided between the water supply source and the inlet port to filter water supplied from the water supply source.

The outlet port may be disposed at the upper side of the other end of the housing, and the partitions may be provided at the upper sides thereof located on the same line as the outlet port with air holes, through which air is discharged.

The housing may include a first housing forming one side thereof in the longitudinal direction and a second housing forming the other side thereof in the longitudinal direction, the first housing and the second housing being coupled to each other by welding, and the partition unit may be mounted in the housing.

The refrigerator may further include a main body having a storage chamber, wherein the housing may be disposed in the storage chamber so that the outlet port is inclined upward.

The partition unit may include a rod extending in the longitudinal direction, the rod being disposed in the center of the water storage part while opposite ends of the rod are supported by the first housing and the second housing, and the partitions may extend from the rod.

Each of the partitions may be provided with a cutoff part, and the communication holes may be defined between the respective cutoff parts and the inside of the housing.

The partitions may be formed in a spiral shape.

The refrigerator may further include a dispenser connected to the outlet port.

The refrigerator may further include a water supply source and an inlet port connected to the water supply source, wherein the inlet port may be disposed adjacent to one end of the water storage part.

In accordance with another aspect, a water tank for refrigerators includes a housing having an inlet port, an outlet port and a long water storage part, and at least one partition disposed at intervals in the longitudinal direction to partition the water storage part into a plurality of storage spaces, the at least one partition having a communication hole.

The inlet port and the outlet port may be disposed at opposite ends of the housing in the longitudinal direction, respectively.

The inlet port and the outlet port may be disposed at one end of the housing in the longitudinal direction, and the water tank may further include a water tube connected to the inlet port so that water introduced through the inlet port is discharged to the other end of the housing in the longitudinal direction.

The at least one partition may include a plurality of partitions, and the communication hole may be formed at each of the partitions so that the communication holes are diametrically opposite to each other in the longitudinal direction.

The at least one partition may be formed in a spiral shape.

The partitions having the communication holes disposed adjacent to the lower side of the water storage part may be provided at the upper sides thereof with air holes, through which air is discharged.

In accordance with a further aspect, a method of manufacturing a water tank for refrigerators includes injection molding a first housing, a second housing and a partition unit, inserting the partition unit into the first housing and the second housing, and welding the first housing and the second housing to each other.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view illustrating the structure of a refrigerator according to an embodiment;

FIG. 2 is a view illustrating the interior of the refrigerator according to the embodiment;

FIG. 3 is a view illustrating a coupling structure of a water purifier of the refrigerator according to the embodiment;

FIG. 4 is an exploded perspective view illustrating a water tank for refrigerators according to an embodiment;

FIG. 5 is a sectional view of the water tank for refrigerators according to the embodiment;

FIG. 6 is a view illustrating a water flow route in the water tank for refrigerators according to the embodiment;

FIG. 7 is an exploded perspective view illustrating a partition unit of a water tank according to another embodiment;

FIG. 8 is a view illustrating a water flow route in the water tank shown in FIG. 7; and

FIG. 9 is a view illustrating a partition unit of a water tank according to a further embodiment.

### DETAILED DESCRIPTION

Reference will now be made in detail to the embodiments, examples of which are illustrated in the accompanying drawings, wherein like reference numerals refer to like elements throughout.

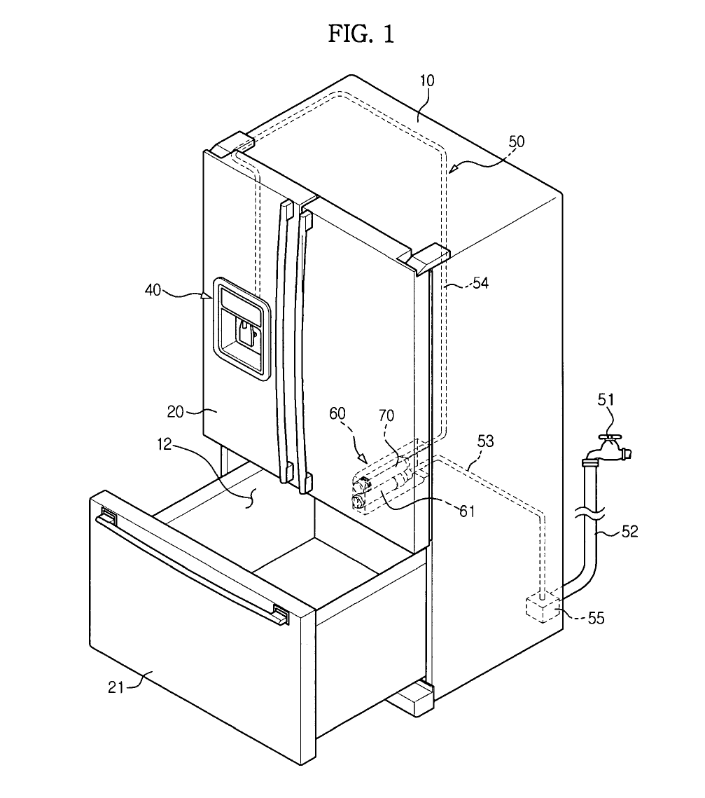

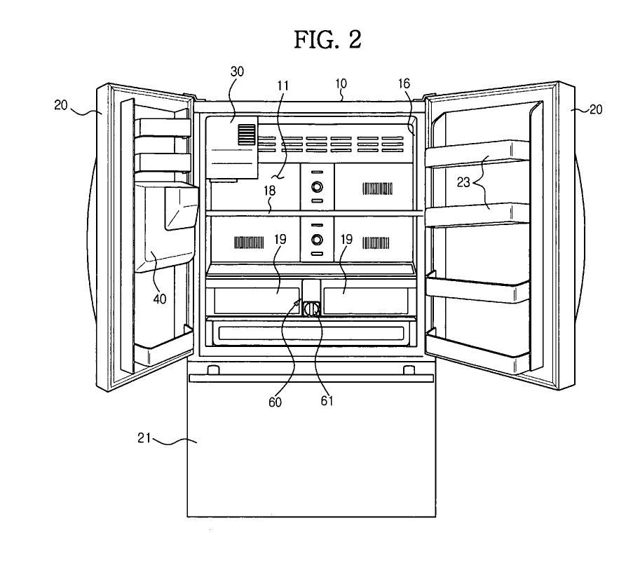

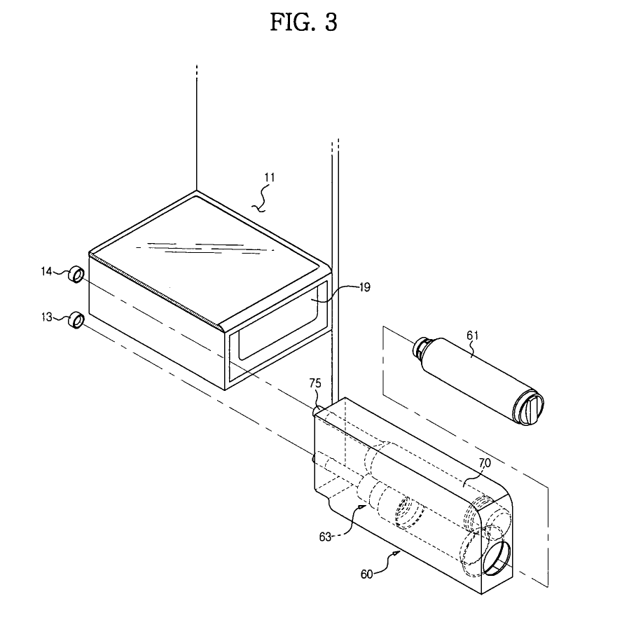

FIG. 1 is a perspective view illustrating the structure of a refrigerator according to an embodiment, FIG. 2 is a view illustrating the interior of the refrigerator according to the embodiment, and FIG. 3 is a view illustrating a coupling structure of a water purifier of the refrigerator according to the embodiment.

Referring to FIGS. 1 to 3, the refrigerator includes a main body 10 having storage chambers 11 and 12 defined therein and doors 20 and 21 to open and close the storage chambers 11 and 12.

The storage chambers 11 and 12 include a refrigerating chamber 11 disposed at the upper part of the main body 10 and a freezing chamber 12 disposed at the lower part of the main body 10. The doors 20 and 21 include a hinged door 20 to open and close the refrigerating chamber 11 and a drawer type door 21 to open and close the freezing chamber 12.

Shelves 18 and drawer type receptacles 19 are provided in the refrigerating chamber 11. An ice maker 30 may be provided in a partitioned space defined at the upper part of the refrigerating chamber 11.

A dispenser 40 to allow a user to take out drinks or ice from the outside may be provided at the door 20.

Also, the refrigerator may further include a water supply system 50 to supply water to the dispenser 40.

The water supply system 50 may include an external water supply source 51, a water supply valve 55 connected to the water supply source 51 to control the supply of water, a water purifier 60 to purify or store the water supplied through the water supply valve 55, and water supply pipes 52, 53 and 54 to guide the water supplied from the water supply source 51 to the dispenser 40.

The water supply pipes 52, 53 and 54 may include a first water supply pipe 52 connected between the water supply source 51 and the water supply valve 55, a second water supply pipe 53 connected between the water supply valve 55 and the water purifier 60, and a third water supply pipe 54 connected between the water purifier 60 and the dispenser 40.

The water supply pipes 52, 53 and 54, the water purifier 60 and the water supply valve 55 may be arranged in various forms depending upon the structure of a water supply channel.

The water purifier 60 may include a filter 61 to filter the water supplied from the water supply source 51 and a water tank 70 to store the water purified by the filter 61.

The water purifier 60 is disposed at the lower part of the refrigerating chamber 11. To improve spatial efficiency of the refrigerating chamber 11, the water purifier 60 may be disposed between the two side by side drawer type receptacles 19.

The filter 61 may be detachably mounted in the water purifier 60 so that the filter 61 is easily replaceable.

The filter 61 may be connected to the water supply source 51 via a valve 63.

In a case in which the filter 61 is mounted in the water purifier 60, the valve 63 may be controlled to supply water from the water supply source 51 to the filter 61. In a case in which the filter 61 is separated from the water purifier 60, the valve 63 may be controlled to supply water from the water supply source 51 to the water tank 70.

The valve 63 may be connected to the second water supply pipe 53 via an inlet connector 13 disposed at the rear wall of the refrigerating chamber 11.

The water purified by the filter 61 may be introduced into the water tank 70.

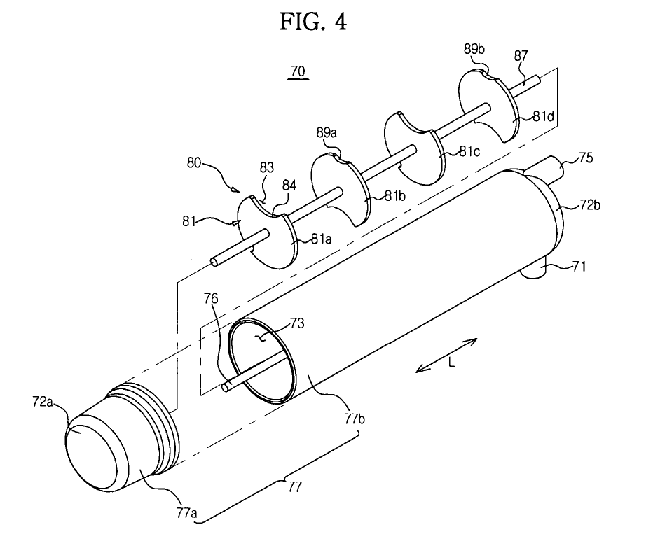

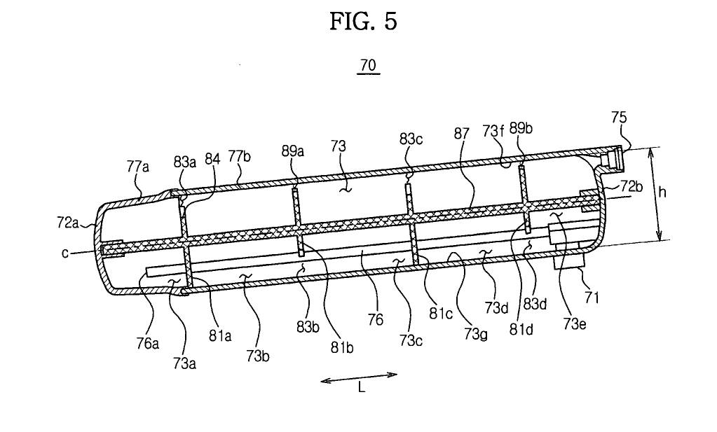

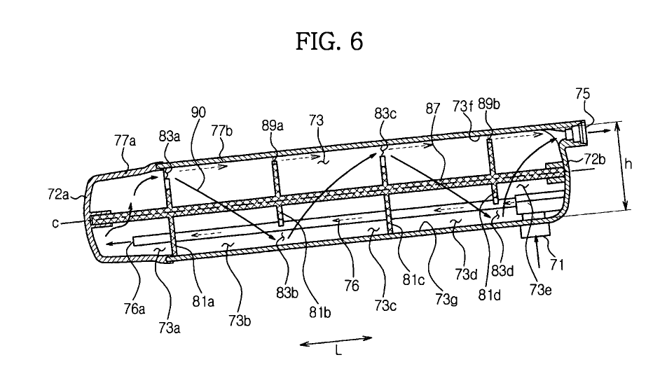

FIG. 4 is an exploded perspective view illustrating a water tank for refrigerators according to an embodiment, FIG. 5 is a sectional view of the water tank for refrigerators according to the embodiment, and FIG. 6 is a view illustrating a water flow route in the water tank for refrigerators according to the embodiment.

The water tank 70 may include a housing 77 having an inlet port 71, through which the water purified by the filter 61 is introduced, a water storage part 73 to store the water introduced through the inlet port 71, and an outlet port 75, through which cool water stored in the water storage part 73 is discharged.

The housing 77 may include a first housing 77a and a second housing 77b coupled to each other. The first housing 77a and the second housing 77b extend lengthwise from one end 72a to the other end 72b in the' longitudinal direction (indicated by an arrow L). In this structure, the size of the water tank 70 mounted in the refrigerating chamber 11 is reduced, thereby improving spatial efficiency of the refrigerating chamber 11.

The first housing 77a and the second housing 77b are injection molded and coupled to the each other in a sealed state using an ultrasonic or vibration welder to define the water storage part 73 to store water therein.

The water storage part 73 is defined in the housing 77 so as to have a length corresponding to the housing 77. The water storage part 73 may be formed in a circular shape in section. Also, the water storage part 73 may be formed in a cylindrical shape having a uniform diameter or in a tapered shape having an increasing diameter.

The inlet port 71 may be connected to a discharge port (not shown) of the valve 63, through which the water purified by the filter 61 is discharged, and the outlet port 75 may be connected to an outlet connector 14 (see FIG. 3) disposed at the lower part of the rear wall of the refrigerating chamber 11.

The outlet connector 14 may be connected to the third water supply pipe 54 connected to the dispenser 40. The water discharged from the water storage part 73 through the outlet port 75 may be supplied to the dispenser 40.

The inlet port 71 and the outlet port 75 may be disposed adjacent to the end 72b of the housing 77 to simplify the structure of the water supply channel of the water supply system 50.

One end of a water tube 76 may be connected to the inlet port 71. The other end of the water tube 76 is disposed adjacent to the end 77a of the housing 77.

The water tube 76 prevents room-temperature water introduced through the inlet port 71 from being directly discharged through the outlet port 75 disposed adjacent to the inlet port 71.

In a case in which the inlet port 71 is disposed opposite to the outlet port 75, the water tube 76 may be omitted.

That is, in a case in which the inlet port 71 and the outlet port 75 are disposed adjacent to each other, the water tube 76 is provided so that room-temperature water introduced through the inlet port 71 is discharged to a region distant from the outlet port 75. In a case in which the inlet port 71 and the outlet port 75 are disposed opposite to each other, the water tube 76 is not provided.

Meanwhile, water introduced into the water storage part 73 through the inlet port 71 flows to the outlet port 75. At this time, room-temperature water introduced through the inlet port 71 is immediately mixed with cool water stored in the water storage part 73. As a result, lukewarm water may be discharged through the outlet port 75.

In this embodiment, therefore, the water tank 70 may include a partition unit 80 to partition the water storage part 73 into predetermined sections so that water supplied to the dispenser 40 is always kept cool.

The partition unit 80 prevents room-temperature water introduced through the inlet port 71 and cool water stored in the water storage part 73 from being mixed with each other so that the cool water stored in the water storage part 73 is discharged to the dispenser 40 first.

The partition unit 80 may include a plurality of partitions 81 to partition the interior of the water storage part 73 into a plurality of storage spaces.

In this embodiment, the partition unit 80 includes four partitions 81. However, the number of the partitions 81 may be changed. For example, only one partition 81 may be provided in a case in which the water storage part 73 is partitioned into two storage spaces.

The partitions 81 may be arranged at intervals in the longitudinal direction of the water storage part 73. The partitions 81 may be disposed at a rod 87, opposite ends of which are supported by opposite ends of the water storage part 73 in the longitudinal direction thereof, at intervals in the axial direction of the rod 87 so that the partitions 81 extend outward from the rod 87 in the radial direction thereof.

The partitions 81 extending from the rod 87 may be inserted into the water storage part 73 through an opening of the second housing 77b.

The rod 87 may be disposed at the center C of a vertical length h of the water storage part 73.

The water storage part 73 is partitioned into a plurality of storage spaces 73a, 73b, 73c, 73d and 73e by the partitions 81a, 81b, 81c and 81d.

Each of the partitions 81a, 81b, 81c and 81d may have a communication hole 83, through which corresponding ones of the storage spaces 73a, 73b, 73c, 73d and 73e communicate with each other.

The communication hole 83 is provided to allow adjacent storage spaces to communicate with each other. The communication hole 83 is formed at each of the partitions 81a, 81b, 81c and 81d in the shape of an opening or a through hole.

In this embodiment, one side of each of the partitions 81 is cut off to form a cutoff part 84, and the communication hole 83 is defined between the inside of the water storage part 73 and the cutoff part 84. However, the shape of the communication hole 83 is not particularly restricted so long as the adjacent storage spaces communicate with each other through the communication hole 83.

The communication holes 83 may include first to fourth communication holes 83a, 83b, 83c and 83d formed at the partitions 81a, 81b, 81c and 81d, respectively.

The communication holes 83a, 83b, 83c and 83d may be disposed so that the communication holes 83a, 83b, 83c and 83d are diametrically opposite to each other in the longitudinal direction L. In this structure, water introduced into the water storage part 73 through the inlet port 71 passes through the first to fifth storage spaces 73a, 73b, 73c, 73d and 73e while flowing upward and downward along a water flow route 90 (see FIG. 6) and is then discharged through the outlet port 75.

That is, the first communication hole 83a disposed adjacent to a discharge port 76a of the water tube 76 is located in the first partition 81a so as to be adjacent to an inner upper side 73f of the water storage part 73. The second communication hole 83b disposed in the second partition 81b adjacent to the first partition 81a is located adjacent to an inner lower side 73g of the water storage part 73.

Also, the third communication hole 83c is located adjacent to the inner upper side 73f of the water storage part 73, and the fourth communication hole 83d is located adjacent to the inner lower side 73g of the water storage part 73.

In the above structure, the water flow route 90, along which water flows to the outlet port 75 in the water storage part 73, is configured in a vertical zigzag or serpentine fashion.

In this case, mixing of water stored in the storage spaces 73a, 73b, 73c, 73d and 73e is restricted, thereby preventing the temperature of cool air stored in the water storage part 73 from being raised by the introduced room-temperature water.

Meanwhile, the first communication hole 83a formed at the first partition 81a, disposed at the side where water supplied from the water supply source 51 is introduced into the water storage part 73, i.e. at the position adjacent to the discharge port 76a of the water tube 76, may be adjacent to the upper side 73f of the water storage part 73 so as to prevent room-temperature water introduced through the inlet port 71 from immediately flowing to the second storage space 73b and being mixed with the water in the second storage space 73b. Even in a case in which only one partition 81 is provided, the same effect is obtained.

Also, the first and third communication holes 83a and 83c disposed adjacent to the upper side 73f of the water storage part 73 may be located higher than the center c of the vertical length h of the water storage part 73, and the second and fourth communication holes 83b and 83d disposed adjacent to the lower side 73g of the water storage part 73 may be located lower than the center c of the vertical length h of the water storage part 73.

In this structure, mixing of water stored in the storage spaces 73a, 73b, 73c, 73d and 73e is minimized.

Also, air holes 89a and 89b may be formed at the upper sides of the second and fourth partitions 81b and 83d having the second and fourth communication holes 83b and 83d, respectively. The air holes 89a and 89b may be formed by cutting off the upper sides of the second and fourth partitions 81b and 83d so that the air holes 89a and 89b are arranged on the same line as the outlet port 75. The air holes 89a and 89b function to rapidly discharge air generated during the supply of water.

That is, the water flow route 90 in the water storage part 73 is bent in a zigzag fashion. As a result, whirlpools are partially generated at the bent portions of the water flow route 90, and therefore, air contained in the water supplied from the water supply source 51 stays in the water storage part 73.

The air staying in the water storage part 73 is compressed by high water pressure and is then expanded at a water dispensing part of the dispenser 40 communicating with the atmosphere with the result that residual water may remain in the water dispensing part of the dispenser 40. In this embodiment, however, such air is rapidly discharged through the air holes 89a and 89b, thereby preventing residual water from remaining in the water dispensing part of the dispenser 40.

Also, in this embodiment, the water tank 70 may be inclined upward to improve a first in first out effect of water in addition to the discharge of air in a case in which the water tank 70 is mounted in the refrigerating chamber 11.

That is, in a case in which the water tank 70 is mounted in the refrigerating chamber 11, the housing 77 may be inclined upward from the end 72a to the end 72b of the housing 77 at which the outlet port 75 is formed, and therefore, the outlet port 75 may be disposed at the upper side of the end 72b of the housing 77 so as to be inclined upward.

The outlet port 75 is disposed on the same line as the first communication hole 83a, the air hole 89a, the third communication hole 83c and the air hole 89b so that air introduced into the water storage part 73 is rapidly discharged through the outlet port 75. In this case, the first communication hole 83a and the third communication hole 83c may also function as the air holes 89a and 89b, respectively.

Meanwhile, although not shown, in a case in which the upper part of the housing 77 is tapered so as to have an increasing diameter in the longitudinal direction thereof, the first communication hole 83a, the air hole 89a, the third communication hole 83c and the air hole 89b, which are disposed on the same line as the outlet port 75, are inclined upward in the longitudinal direction thereof, and therefore, the housing 77 is mounted in the refrigerating chamber 11 in a horizontal state.

In the above structure, room-temperature water from the water supply source 51 is supplied into the water purifier 60 via the water supply valve 55. In this embodiment, the water purifier 60 has the filter 61. In a case in which the filter 61 is not provided, however, the water may be immediately introduced into the water tank 70.

The water purified by the filter 61 is introduced through the inlet port 71, as shown in FIG. 6. The water introduced through the inlet port 71 passes through the water tube 76 and is then discharged into the first storage space 73a of the water storage part 73, which is the most distant from the output port 75.

The water stored in the first storage space 73a is introduced into the second to fifth storage spaces 73b, 73c, 73d and 73e via the first to fourth communication holes 83a, 83b, 83c and 83d, respectively. The water stored in the second to fifth storage spaces 73b, 73c, 73d and 73e is cooled by cool air from the refrigerating chamber 11.

Upon operating the dispenser 40, room-temperature water from the water supply source 51 is supplied into the water tank 70. However, the water storage part 73 is partitioned by the partitions 81a, 81b, 81c and 81d, and therefore, immediate mixing of the room-temperature water and cool water is prevented.

That is, the water flow route 90, along which the room-temperature water introduced into the water storage part 73 through the inlet port 71 flows to the outlet port 75, is configured in a vertical zigzag fashion, and therefore, mixing of the room-temperature water and cool water is considerably reduced.

Consequently, the water supplied into the dispenser 40 is kept cool so that a consumer may drink cool water.

Also, air supplied to the water storage part 73 during the supply of water is rapidly discharged through the outlet port 75 via the first communication hole 83a, the air hole 89a, the third communication hole 83c and the air hole 89b, which are arranged in a line in the longitudinal direction, thereby preventing residual water from remaining in the dispenser 40 according to the opening and closing of the valve. That is, the occurrence of a phenomenon in which water drops from a water dispensing pipe of the dispenser 40 after a lever to provide a dispensing operation signal is turned off is prevented.

Meanwhile, in a case in which the water tank 70 is formed in a zigzag shape to achieve first in first out of cool water in the water tank 70, spatial efficiency of the storage chamber may be lowered due to the increase in size of the water tank 70, and productivity may be reduced due to difficulty in forming the water tank 70. In this embodiment, the water flow route 90, along which water flows upward and downward, of the water tank 70 is formed by the partition unit 80. Consequently, the structure of the water tank 70 is simplified, thereby improving productivity thereof.

That is, the first housing 77a, the second housing 77b and the partition unit 80 are separately injection molded, and the coupling portions of the first and second housings 77a and 77b are connected to each other by welding in a state in which the partition unit 80 is disposed in the first and second housings 77a and 77b to manufacture the water tank 70. Consequently, reliability of the water tank 70 is improved.

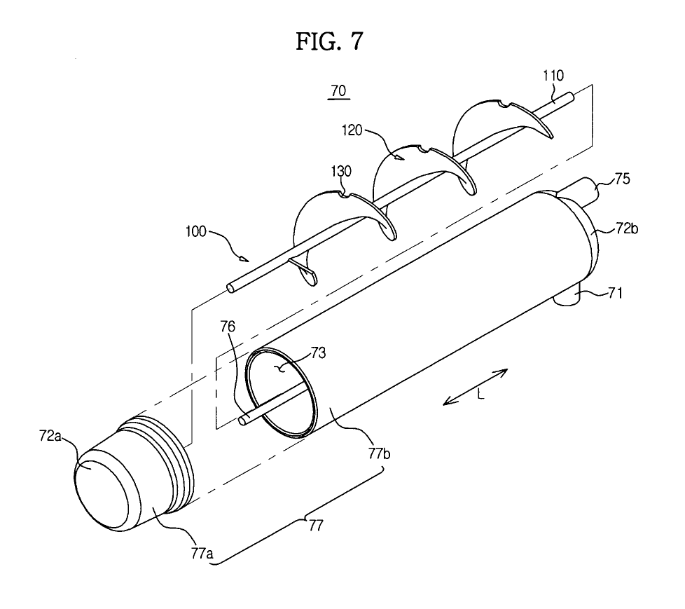

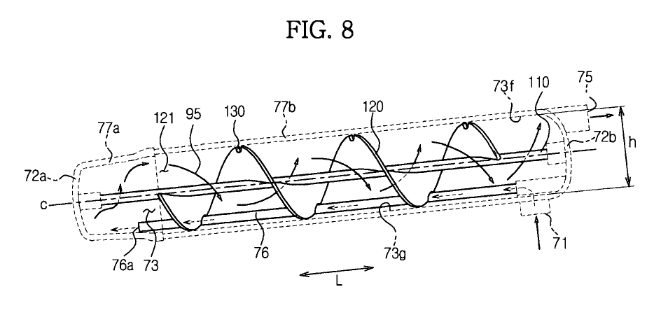

Hereinafter, another embodiment of the present invention will be described. Components of this embodiment identical to those of the previous embodiment will not be described. FIG. 7 is an exploded perspective view illustrating a partition unit of a water tank according to another embodiment of the present invention, and FIG. 8 is a view illustrating a water flow route in the water tank shown in FIG. 7.

Referring to FIGS. 7 and 8, a partition unit 100 to partition a water storage part 73 into a plurality of storage spaces may include a spiral partition 120.

The partition unit 100 may include a rod 110, opposite ends of which are supported by opposite ends of the water storage part 73 in the longitudinal direction L and a partition 120 extending in the axial direction of the rod 110 in a spiral shape.

The partition 120 may extend from the rod 120 to the inside of the water storage part 73. Also, air holes 130, through which air is discharged, may be formed at sections of the partition 120 adjacent to an upper side 73f of the water storage part 73.

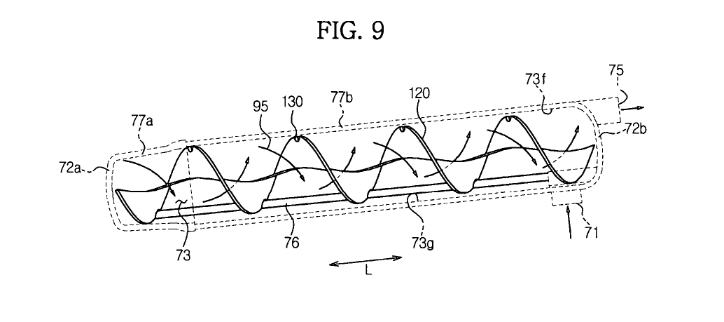

In this embodiment, the partition 120 extends from the rod 110. However, as shown in FIG. 9, the partition unit 100 may include only a spiral partition 120. In this case, opposite ends of the spiral partition 120 may be supported by opposite ends of the water storage part 73.

Also, the spiral partition 120 is configured to define communication holes 121 between the inner wall of the water storage part 73 and sections of the partition 120 so that storage spaces partitioned by the partition 120 communicate with each other through the communication holes 121.

In a case in which the partition unit 100, including the spiral partition 120, is mounted in the water storage part 73, the water storage part 73 is partitioned into a plurality of storage spaces, and therefore, mixing of room-temperature water introduced through an inlet port 71 and a water tube 76 and cool water stored in the water storage part 73 is reduced.

That is, a water flow route 95, along which water flows to an outlet port 75 in the water storage part 73, is configured so that the water flows upward and downward along the spiral partition 120 in a spiral fashion, and therefore, mixing of room-temperature water introduced into the water storage part 73 and cool water stored in the water storage part 73 is reduced.

As is apparent from the above description, in the refrigerator with the water tank according to the embodiment of the present invention, spatial efficiency is improved, and, in addition, reliability of the dispenser based on first in and first out is improved.

Also, the water tank is manufactured so as to have a simple structure, and therefore, durability and productivity of the water tank are improved.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A water tank for refrigerators, comprising:
a housing having an inlet port, an outlet port and a water storage part to store water introduced through the inlet port;
a partition unit comprising at least one partition mounted in the water storage part to partition the water storage part into a plurality of storage spaces;
a communication hole formed at the at least one partition to allow the storage spaces partitioned by the at least one partition to communicate with each other; and
a water flow route along which the water introduced into the water storage part through the inlet port flows to the outlet port via the communication hole,
wherein the communication hole is formed at the at least one partition so that the water flow route has a serpentine form.

2. The water tank according to claim 1, wherein the water storage part extends lengthwise in a longitudinal direction.

3. The water tank according to claim 1, wherein the at least one partition is provided with a cutoff part, and
the communication hole is defined between the cutoff part and an inside of the housing.

4. The water tank according to claim 2, wherein the inlet port and the outlet port are disposed at opposite ends of the water storage part in the longitudinal direction, respectively, and
the communication hole formed at the at least one partition adjacent to the inlet port is disposed adjacent to an upper side of the water storage part.

5. The water tank according to claim 2, wherein the inlet port and the outlet port are disposed at one end of the water storage part in the longitudinal direction, and
the water tank further comprises a water tube communicating with the inlet port so that water introduced through the inlet port is discharged to a portion adjacent to the other end of the water storage part in the longitudinal direction.

6. The water tank according to claim 2, wherein the partition unit further comprises a rod, opposite ends of which are supported by opposite ends of the water storage part in the longitudinal direction, respectively, and the at least one partition extends outward from the rod in a radial direction.

7. The water tank according to claim 2, wherein the partition unit further comprises a rod, opposite ends of which are supported by opposite ends of the water storage part in the longitudinal direction, respectively, and the at least one partition extends from the rod in a spiral shape.

8. The water tank according to claim 3, wherein the at least one partition having the communication hole disposed adjacent to a lower side of the water storage part is provided at an upper side thereof with an air hole, through which air is discharged.

9. The water tank according to claim 2, wherein the communication hole formed at the at least one partition having the communication hole disposed adjacent to an upper side of the water storage part is located higher than a center of a vertical length of the housing.

10. The water tank according to claim 9, wherein the communication hole formed at the at least one partition having the communication hole disposed adjacent to a lower side of the water storage part is located lower than the center of the vertical length of the housing.

11. The water tank according to claim 2, wherein the housing comprises a first housing forming one side thereof in the longitudinal direction and a second housing forming the other side thereof in the longitudinal direction, the first housing and the second housing being coupled to each other, and
the partition unit is injection molded and is mounted in the housing.

12. The water tank according to claim 11, wherein the first housing and the second housing are welded to each other.

13. The water tank according to claim 11, wherein the partition unit further comprises a rod extending in the longitudinal direction so that one end of the rod is supported by the first housing and the other end of the rod is supported by the second housing, the rod being disposed at a center of a vertical length of the water storage part, and
the at least one partition extends from the rod toward an inside of the housing.

14. A refrigerator comprising:
a housing having a water storage part extending from one end to the other end in a horizontal direction and a water flow route along which water introduced into the water storage part through a portion adjacent to one end flows to an outlet port disposed adjacent to the other end; and
a partition unit comprising a plurality of partitions arranged in the water storage part at intervals in a longitudinal direction to partition the water storage part, each of the partitions having a communication hole, wherein
the communication holes formed at the partitions are diametrically opposite to each other so that the water flow route has a serpentine form.

15. The refrigerator according to claim 14, further comprising:
a water supply source;
an inlet port having one end connected to the water supply source and the other end connected to a portion adjacent to the other end of the water storage part; and
a water tube communicating with the inlet port to allow water introduced through the inlet port to be discharged at a portion adjacent to one end of the housing.

16. The refrigerator according to claim 15, wherein the communication hole formed at one of the partitions adjacent to a discharge port of the water tube is disposed adjacent to an upper side of the water storage part.

17. The refrigerator according to claim 15, further comprising a filter provided between the water supply source and the inlet port to filter water supplied from the water supply source.

18. The refrigerator according to claim 14, wherein the outlet port is disposed at an upper side of the other end of the housing, and
the partitions are provided at upper sides thereof located on the same line as the outlet port with air holes, through which air is discharged.

19. The refrigerator according to claim 14, wherein the housing comprises a first housing forming one side thereof in the longitudinal direction and a second housing forming the other side thereof in the longitudinal direction, the first housing and the second housing being coupled to each other by welding, and
the partition unit is mounted in the housing.

20. The refrigerator according to claim 18, further comprising:
a main body having a storage chamber,
wherein the housing is disposed in the storage chamber so that the outlet port is inclined upward.

21. The refrigerator according to claim 19, wherein the partition unit comprises a rod extending in the longitudinal direction,
the rod being disposed in a center of the water storage part while opposite ends of the rod are supported by the first housing and the second housing, and
the partitions extend from the rod.

22. The refrigerator according to claim 21, wherein each of the partitions is provided with a cutoff part, and
the communication holes are defined between the respective cutoff parts and an inside of the housing.

23. The refrigerator according to claim 21, wherein the partitions are formed in a spiral shape.

24. The refrigerator according to claim 14, further comprising a dispenser connected to the outlet port.

25. The refrigerator according to claim 14, further comprising:
a water supply source; and
an inlet port connected to the water supply source, wherein
the inlet port is disposed adjacent to one end of the water storage part.

26. A water tank for refrigerators, comprising:
a housing having an inlet port, an outlet port and a long water storage part; and
at least one partition disposed at intervals in a longitudinal direction to partition the water storage part into a plurality of storage spaces, the at least one partition having a communication hole.

27. The water tank according to claim 26, wherein the inlet port and the outlet port are disposed at opposite ends of the housing in the longitudinal direction, respectively.

28. The water tank according to claim 26, wherein the inlet port and the outlet port are disposed at one end of the housing in the longitudinal direction, and
the water tank further comprises a water tube connected to the inlet port so that water introduced through the inlet port is discharged to the other end of the housing in the longitudinal direction.

29. The water tank according to claim 26, wherein the at least one partition comprises a plurality of partitions, and the communication hole is formed at each of the partitions so that the communication holes are diametrically opposite to each other in the longitudinal direction.

30. The water tank according to claim 26, wherein the at least one partition is formed in a spiral shape.

31. The water tank according to claim 29, wherein the partitions having the communication holes disposed adjacent to a lower side of the water storage part are provided at upper sides thereof with air holes, through which air is discharged.

32. A method of manufacturing a water tank for refrigerators, comprising:
injection molding a first housing, a second housing and a partition unit;
inserting the partition unit into the first housing and the second housing; and
welding the first housing and the second housing to each other.
